(19) United States
(12) Patent Application Publication
(10) Pub. No.: US 2018/0335632 A1
(43) Pub. Date: Nov. 22, 2018

(54) HEAD-MOUNTED DISPLAY APPARATUS

(71) Applicant: Acer Incorporated, New Taipei City (TW)

(72) Inventors: Chun-Kai CHO, New Taipei City (TW); Yu-Lin HUANG, New Taipei City (TW); Chun-Ta CHEN, New Taipei City (TW)

(21) Appl. No.: 15/861,081

(22) Filed: Jan. 3, 2018

(30) Foreign Application Priority Data
May 18, 2017 (TW) 106116434

(51) Int. Cl. G02B 27/01

(52) U.S. Cl. CPC G02B 27/0176; G02B 2027/0178

(57) ABSTRACT

A head-mounted display apparatus includes a display device, and a headband structure connected to two sides of the display device. The headband structure includes a side-connecting band, an elastic band, and a rear-connecting band. The side-connecting band is connected to the display device. One end of the elastic band is connected to the side-connecting band, and the other end is connected to the rear-connecting band.

### CROSS-REFERENCE TO RELATED APPLICATIONS

This Application claims priority of Taiwan Patent Application No. 106116434 filed on May 18, 2017, the entirety of which is incorporated by reference herein.

### BACKGROUND OF THE INVENTION

### Field of the Invention

The present disclosure relates to a display apparatus, and in particular to a head-mounted display apparatus.

### Description of the Related Art

A conventional head-mounted display is configured to be worn on the user's head, and to provide 2D or 3D images to the user. The conventional head-mounted display includes a display panel, and two lenses that correspond to the user's two eyes. The display panel is configured to display a left-eye image and a right-eye image, respectively entering through the left eye and the right eye via the lenses, and a 3D image is presented by the left-eye image and the right-eye image.

In order for the user to wear the head-mounted display on his head, a headband is utilized. In general, the head-mounted display worn on the user's head requires complex processes and adjustments. Moreover, during the operation of the head-mounted display, the user may move or swing his head, causing the head-mounted display to become displaced relative from the head, causing discomfort or affecting the proper use of the device.

Although conventional head-mounted displays have been generally adequate for their intended purposes, they have not been entirely satisfactory in all respects. Consequently, it is desirable to provide a solution for improving upon conventional head-mounted displays.

### BRIEF SUMMARY OF THE INVENTION

The present disclosure provides a head-mounted display apparatus. The display device of the head-mounted display apparatus can be stably disposed on the user's head by using a headband structure. Moreover, the head-mounted display apparatus can provide comfort when worn.

The present disclosure provides a head-mounted display apparatus including a display device and a first headband structure connected to two sides of the display device. The first headband structure includes a first side-connecting band, a first elastic band, and a first rear-connecting band. The first side-connecting band is connected to the display device. The first elastic band includes a first end and a second end. The first end is connected to the first side-connecting band. The first rear-connecting band is connected to the second end of the first elastic band. The elasticity of the first elastic band is greater than the elasticity of the first side-connecting band and the first rear-connecting band. The material of the first elastic band is different from the materials of the first side-connecting band and the first rear-connecting band.

In some embodiments, the first elastic band is woven elastic fibers. In some embodiments, the first elastic band is made from a mass elasticity material.

In some embodiments, the first side-connecting band includes thermoplastic polyurethane (TPU). In some embodiments, the first side-connecting band is hard, and is non-flexible. In some embodiments, the first side-connecting band is flexible, and is not stretchable.

In some embodiments, the first elastic band is not stacked on the first side-connecting band and the first rear-connecting band.

In some embodiments, the first end is connected to the first side-connecting band via a first glue, and the first rear-connecting band is connected to the second end of first elastic band via a second glue.

In some embodiments, the head-mounted display apparatus further includes a first cladding layer covering the first side-connecting band and the first end of the first elastic band. The head-mounted display apparatus further includes a second cladding layer covering the first rear-connecting band and the second end of the first elastic band.

In some embodiments, the head-mounted display apparatus further includes a second headband structure. Two ends of the second headband structure are connected to the first headband structure.

In some embodiments, the second headband structure includes a second side-connecting band, a second elastic band and a second rear-connecting band. The second side-connecting band is connected to the first side-connecting band. The second elastic band is connected to the second side-connecting band. The second rear-connecting band is connected to the first elastic band. The elasticity of the second elastic band is greater than the elasticity of the second side-connecting band and the second rear-connecting band. The material of the second elastic band is different from the materials of the second side-connecting band and the second rear-connecting band.

In some embodiments, the materials of the second elastic band and the first elastic band are the same. The materials of the first side-connecting band, the first rear-connecting band, the second side-connecting band, and the second rear-connecting band are the same.

In some embodiments, the second elastic band is connected to the second side-connecting band via a third glue, and the second rear-connecting band is connected to the first elastic band via a fourth glue.

In some embodiments, the head-mounted display apparatus further includes a third cladding layer covering the second side-connecting band and the end of the second elastic band. The head-mounted display apparatus further includes a fourth cladding layer covering the second rear-connecting band and the other end of the second elastic band.

In some embodiments, the first side-connecting band and the second side-connecting band are formed as a Y-shaped structure.

In some embodiments, the head-mounted display apparatus further includes a top headband structure connected to the first headband structure and the display device.

In conclusion, the display device of the head-mounted display apparatus of the present disclosure can be stably disposed on the user's head by the elastic band, and the head-mounted display apparatus can provide comfort.

### BRIEF DESCRIPTION OF THE DRAWINGS

The invention can be more fully understood by reading the subsequent detailed description and examples with references made to the accompanying drawings, wherein:

FIG. 1 is a perspective view of a head-mounted display apparatus in accordance with some embodiments of the present disclosure.

FIG. 2 is a cross-sectional view of the head-mounted display apparatus in accordance with some embodiments of the present disclosure.

FIG. 3 and FIG. 4 are rear views of the first headband structure, the second headband structure, and the top headband structure in accordance with some embodiments of the present disclosure.

FIG. 5 is a top view of the first headband structure in accordance with some embodiments of the present disclosure.

FIG. 6 is a first headband structure in accordance with some embodiments of the present disclosure.

FIG. 7 is a top view of the second headband structure in accordance with some embodiments of the present disclosure.

FIG. 8 is cross-sectional view of the second headband structure in accordance with some embodiments of the present disclosure.

### DETAILED DESCRIPTION OF THE INVENTION

The following disclosure provides many different embodiments, or examples, for implementing different features of the present disclosure. Specific examples of components and arrangements are described below to simplify the present disclosure. For example, the formation of a first feature over or on a second feature in the description that follows may include embodiments in which the first and second features are formed in direct contact, and may also include embodiments in which additional features may be formed between the first and second features, such that the first and second features may not be in direct contact.

The words, such as “first” or “second”, in the specification are for the purpose of clarity of description only, and are not relative to the claims or meant to limit the scope of the claims. In addition, terms such as “first feature” and “second feature” do not indicate the same or different features.

Spatially relative terms, such as upper and lower, may be used herein for ease of description to describe one element or feature's relationship to another element(s) or feature(s) as illustrated in the figures. The spatially relative terms are intended to encompass different orientations of the device in use or operation in addition to the orientation depicted in the figures. The shape, size, thickness, and angle of tilt in the drawings may not be drawn to scale or simplified for clarity of discussion; rather, these drawings are merely intended for illustration.

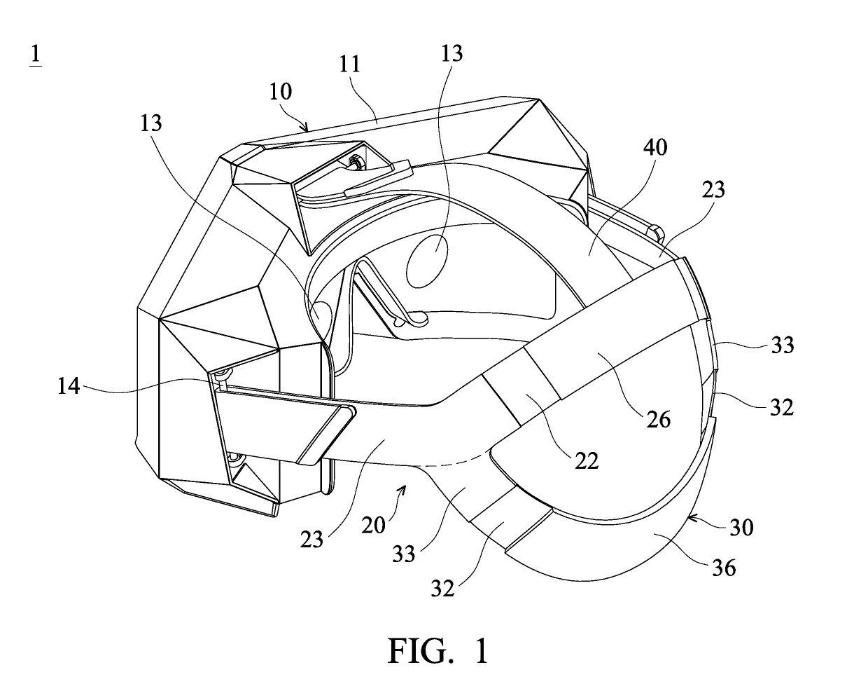

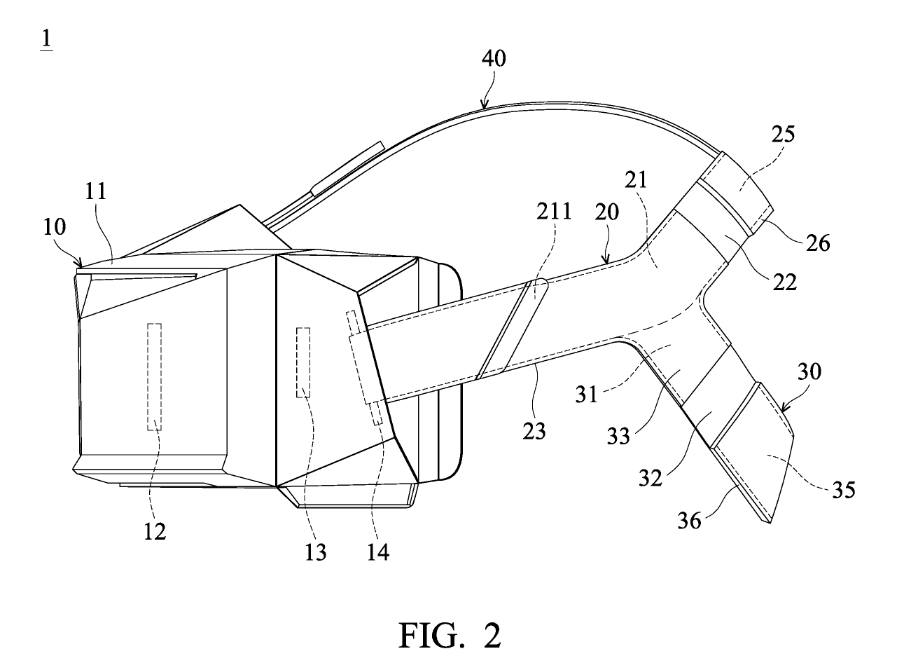

FIG. 1 is a perspective view of a head-mounted display apparatus 1 in accordance with some embodiments of the present disclosure. FIG. 2 is a cross-sectional view of the head-mounted display apparatus 1 in accordance with some embodiments of the present disclosure. The head-mounted display apparatus 1 is configured to be worn on the head of the user, and provide 2D (two dimensional) images or 3D (three dimensional) image for users. In some embodiment, the head-mounted display apparatus 1 may be a head-mounted virtual reality apparatus.

The head-mounted display apparatus 1 includes a display device 10, a first headband structure 20, a second headband structure 30, and a top headband structure 40. The display device 10 includes a housing 11, a display panel 12, and, and two lenses 13. The display panel 12 is disposed in the housing 11. The display panel 12 may be a liquid-crystal display panel (LCD panel) or an organic light-emitting diode panel (OLED panel), and is configured to display an image.

In some embodiments, the image includes a left-eye image and a right-eye image different from the left-eye image. In some embodiments, there are two display panels 12, displaying the same image, or respectively displaying a left-eye image and a right-eye image.

The lenses 13 are disposed on the housing 11 and face the display panel 12. In this embodiment, the lenses 13 are convex lenses. When the user wears the head-mounted display apparatus 1, the lenses 13 correspond to the left eye and the right eye.

The images generated by the display panel 13 enter into the user's eye via the lenses 13. When the head-mounted display apparatus 1 provides a 3D image, the head-mounted display apparatus 1 displays a left-eye image and a right-eye image. A 3D image is presented to the user, when the user watches the left-eye image with the left eye, and watches the right-eye image with the right eye.

The first headband structure 20 is connected to two opposite sides of the display device 10. Two ends of the second headband structure 30 are respectively connected to the first headband structure 20. Two ends of the top headband structure 40 are respectively connected to the first headband structure 20 and the display device 10. In this embodiment, the top headband structure 40 is designed referring to the first headband structure 20 and/or the second headband structure 30.

When the user wears the head-mounted display apparatus 1, the display device 10 is put on the face in front of the user's eyes. The first headband structure 20 surrounds two opposite sides and the rear of the head. The second headband structure 30 is put on the rear of the head. The top headband structure 40 is put on the top of the head. Therefore, by using the first headband structure 20, the second headband structure 30, and the top headband structure 40 as described above, the display device 10 can be stably disposed on the user's head.

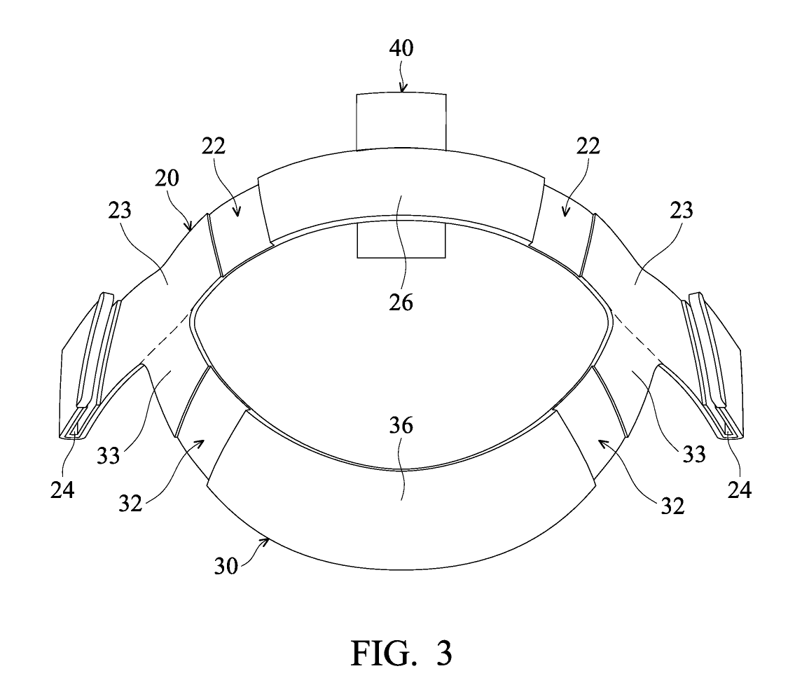

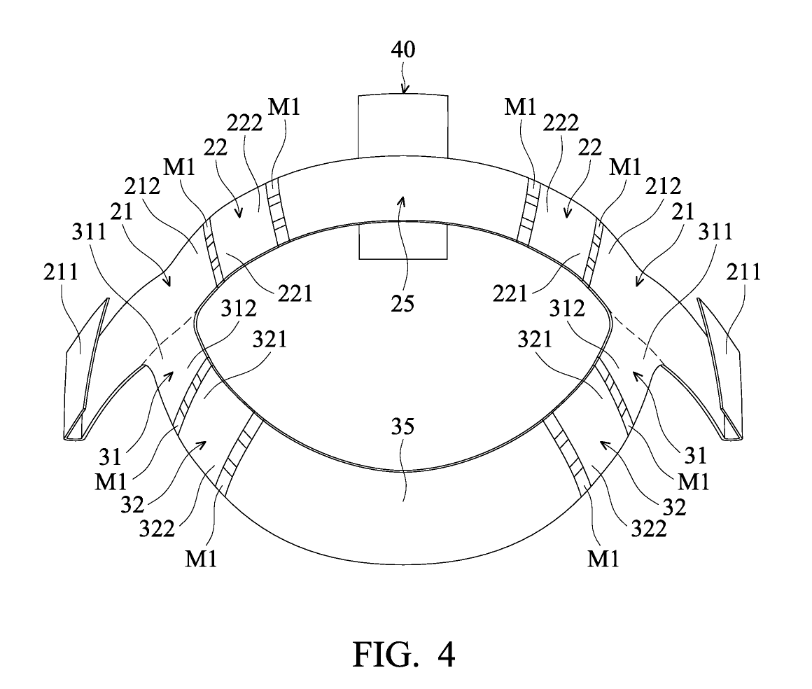

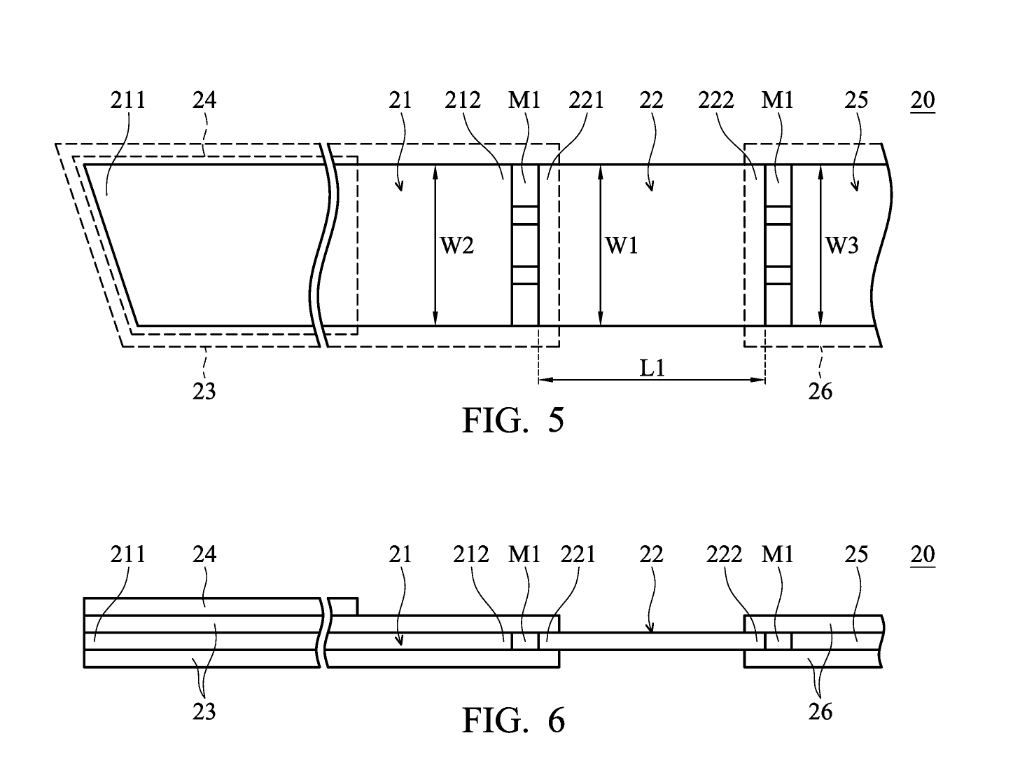

FIG. 3 and FIG. 4 are rear views of the first headband structure 20, the second headband structure 30, and the top headband structure 40 in accordance with some embodiments of the present disclosure. A cladding layer is not illustrated in FIG. 4. FIG. 5 is a top view of the first headband structure 20 in accordance with some embodiments of the present disclosure. FIG. 6 is a first headband structure 20 in accordance with some embodiments of the present disclosure.

The first headband structure 20 includes two first side-connecting bands 21, two first elastic bands 22, two cladding layers 23, two velcro structures 24, a first rear-connecting band 25, and a cladding layer 26. When the user wears the head-mounted display apparatus 1, the first side-connecting band 21 is located at two opposite sides of the user's head. The first rear-connecting band 25 is located at the rear of the user's head, and opposite to the display device 10.

The first side-connecting band 21 is connected to the display device 10. In this embodiment, the first side-connecting bands 21 surround the retaining rods 14 at two opposite sides of the housing 11. In other words, the first side-connecting band 21 is bent at the retaining rod 14. The end 212 of the first side-connecting band 21 is connected to the end 221 of the first elastic band 22 via the glue M1.

The material of the first side-connecting band 21 may be thermoplastic polyurethane (TPU). In some embodiments, the first side-connecting band 21 is hard, and is non-flexible. In some embodiments, the first side-connecting band 21 is flexible, and is not stretchable.

The end 221 of the first elastic band 22 is connected to the end 212 of the first side-connecting band 21 via the glue M1. The end 222 of the first elastic band 22 is connected to the end of the first rear-connecting band 25 via the glue M1.

In some embodiments, the first elastic band 22 is woven elastic fibers. In some embodiments, the first elastic band 22 is made from a mass elasticity material, such as rubber or polyesteramide.

In this embodiment, there are two first elastic bands 22. In some embodiments, there may be one, or at least three, first elastic bands 22. Moreover, the location of the first elastic band 22 disposed on the first headband structure 20 is not limited. The number of first side-connecting bands 21 and first rear-connecting bands 25 corresponds to the number of first elastic bands 22.

For example, when there is one first elastic band 22, the location of the first elastic band 22 corresponds to the rear, the left side, or the right side of the user's head. Moreover, there may be one first side-connecting band 21, and the end of the first rear-connecting band 25 is connected to the display device 10.

The cladding layer 23 covers the first side-connecting band 21, the glue M1, and the end 221 of the first elastic band 22. In this embodiment, the cladding layer 23 adheres to the first side-connecting band 21, the glue M1, and the end 221 of the first elastic band 22. Therefore, the combination of the first side-connecting band 21 and the first elastic band 22 is improved. In this embodiment, the material of the cladding layer 23 is nylon.

The velcro structure 24 is disposed on a surface of the cladding layer 23. When the first side-connecting band 21 is bent around the retaining rod 14, the end 211 of the first side-connecting band 21 can be affixed to the central area of the first side-connecting band 21 via the velcro structure 24. Therefore, the relative position between the end 211 of the first side-connecting band 21 and the retaining rod 14 of the display device 10 can be retained.

When the head-mounted display apparatus 1 is worn on the user's head, the length of the first headband structure 20 around the head can be adjusted by pulling the end 211 of the first side-connecting band 21, and fixing the end 211 of the first side-connecting band 21 to the central area of the first side-connecting band 21 via the velcro structure 24.

Two ends of the first rear-connecting band 25 are connected to the end 222 of the first elastic band 22 via the glue M1. The materials of the first rear-connecting band 25 and the first side-connecting band 21 may be the same. The material of the first rear-connecting band 25 may be thermoplastic polyurethane. In some embodiments, the first rear-connecting band 25 is hard, and is non-flexible. In some embodiments, the first rear-connecting band 25 is flexible, and is not stretchable.

The cladding layer 26 covers the first rear-connecting band 25, the glue M1, and the end 222 of the first elastic band 22. In this embodiment, the cladding layer 26 adheres to the first rear-connecting band 25, the glue M1, and the end 222 of the first elastic band 22. Therefore, the combination of the first rear-connecting band 25 and the first elastic band 22 is improved. In this embodiment, the material of the cladding layer 26 is nylon. The materials of the cladding layer 26 and the cladding layer 23 are the same.

In this embodiment, the elasticity of the first elastic band 22 is greater than the elasticity of the first side-connecting band 21 and the first rear-connecting band 25. The material of the first elastic band 22 is different from the materials of the first side-connecting band 21 and the first rear-connecting band 25.

As shown in FIG. 5 and FIG. 6, the first side-connecting band 21, the glue M1, and the first rear-connecting band 25 are located on the same plane. In a direction perpendicular to the plane or the extension path of the first headband structure 20, the first elastic band 22 is not stacked on the first side-connecting band 21 and the first rear-connecting band 25. Therefore, in this embodiment, the thickness of the first headband structure 20 is not increased due to the glue M1 connected to the first side-connecting band 21 and first rear-connecting band 25. Moreover, the appearance of the first headband structure 20 can be improved.

The width W1 of the first elastic band 22 is the same or substantially the same as the width W2 of the first side-connecting band 21 and the width W3 of the first rear-connecting band 25. The length of the first side-connecting band 21 or the length of the first rear-connecting band 25 is greater than 3 times the length L1 of the first elastic band 22. The lengths of the first side-connecting band 21 and the first rear-connecting band 25, and the first elastic band 22 are measured along the extension path of the first headband structure 20. The widths W1, W2 and W3 are measured in the same direction. Moreover, the longest length of the first elastic band 22, which is stretched, is longer than 1.2 times or 1.5 times the first elastic band 22, which is not stretched.

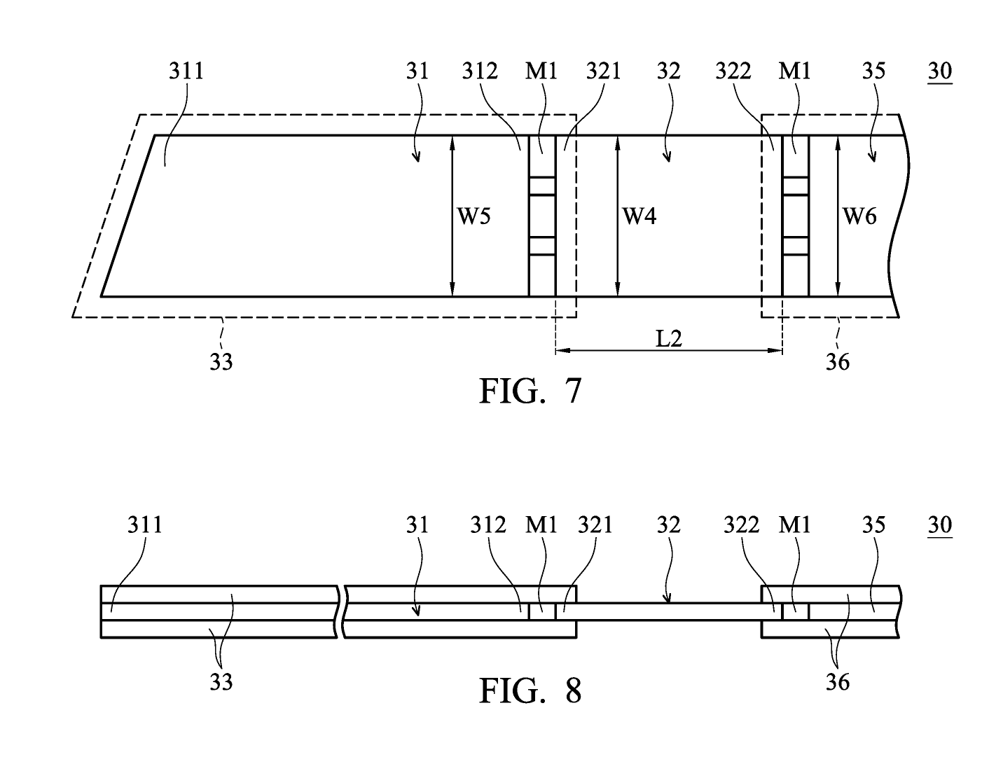

FIG. 7 is a top view of the second headband structure 30 in accordance with some embodiments of the present disclosure. FIG. 8 is cross-sectional view of the second headband structure 30 in accordance with some embodiments of the present disclosure. The second headband structure 30 includes two second side-connecting bands 31, two second elastic bands 32, two cladding layers 33, a second rear-connecting band 35, and a cladding layer 36. When the head-mounted display apparatus 1 is worn by user, the second side-connecting band 31 is located at the left and right side of the user's head or the left and right side of the rear of the user's head. The second rear-connecting band 35 is located at the rear or the center of the rear of the user's head, and opposite to the display device 10.

The second side-connecting band 31 is connected to the first side-connecting band 21. In this embodiment, the end 311 of the second side-connecting band 31 is directly connected to the first side-connecting band 21. The end 312 of the second side-connecting band 31 is connected to the end 321 of the second elastic band 32 via the glue M1. In some embodiments, the second side-connecting band 31 and the first side-connecting band 21 are formed as a single piece. The first side-connecting band 21 and the second side-connecting band 31 are formed as a Y-shaped structure.

The material of the second side-connecting band 31 is the same as the material of the first side-connecting band 21 or the first rear-connecting band 25. The material of the second side-connecting band 31 may be thermoplastic polyurethane. In some embodiments, the second side-connecting band 31 is hard, and is non-flexible. In some embodiments, the second side-connecting band 31 is flexible, and is not stretchable.

The end 321 of the second elastic band 32 is connected to the end 312 of the second side-connecting band 31 via the glue M1. The end 322 of the second elastic band 32 is connected to the end of the second rear-connecting band 35 via the glue M1.

The materials of the second elastic band 32 and the first elastic band 22 are the same. In some embodiments, the second elastic band 32 is woven elastic fibers. In some embodiments, the second elastic band 32 is made from a mass elasticity material.

In this embodiment, there are two second elastic bands 32. In some embodiments, there may be one second elastic band 32, or there may be at least three. Moreover, the location of the second elastic band 32 disposed on the second headband structure 30 is not limited. The number of second side-connecting bands 31 and second rear-connecting bands 35 corresponds to the number of second elastic bands 32.

For example, there may be one second elastic band 32, and the location of the second elastic band 32 corresponds to the rear, the left side, or the right side of the user's head. Moreover, there may be one second side-connecting band 31, and the end of the second rear-connecting band 35 is connected to the first side-connecting band 21.

The cladding layer 33 covers the second side-connecting band 31, the glue M1, and the end 321 of the second elastic band 32. In this embodiment, the cladding layer 33 adheres to the second side-connecting band 31, the glue M1, and the end 321 of the second elastic band 32. Therefore, the combination of the second side-connecting band 31 and the second elastic band 32 is improved. In this embodiment, the material of the cladding layer 33 is nylon. The material of the cladding layer 33 is the same as the material of the cladding layer 23 or the cladding layer 26.

Two ends of the second rear-connecting band 35 are connected to the end 322 of the second elastic band 32 via the glue M1. The materials of the second rear-connecting band 35 and the second side-connecting band 31 are the same. The material of the second rear-connecting band 35 is thermoplastic polyurethane. In some embodiments, the second rear-connecting band 35 is hard, and is non-flexible. In some embodiments, the second rear-connecting band 35 is flexible, and is not stretchable.

The cladding layer 36 covers the second rear-connecting band 35, the glue M1, and the end 322 of the second elastic band 32. In this embodiment, the cladding layer 36 adheres to the second rear-connecting band 35, the glue M1, and the end 322 of the second elastic band 32. Therefore, the combination of the second rear-connecting band 35 and the second elastic band 32 is improved. In this embodiment, the material of the cladding layer 36 is nylon. The materials of the cladding layer 36 and the cladding layer 33 are the same.

In this embodiment, the elasticity of the second elastic band 32 is greater than the elasticity of the second side-connecting band 31 and the second rear-connecting band 35. The material of the second elastic band 32 is different from the materials of the second side-connecting band 31 and the second rear-connecting band 35.

As shown in FIG. 7 and FIG. 8, the second side-connecting band 31, the glue M1, and the second rear-connecting band 35 are located on a plane. In a direction perpendicular to the plane or the extension path of the second headband structure 30, the second elastic band 32 is not stacked on the second side-connecting band 31 and the second rear-connecting band 35. Therefore, in this embodiment, the thickness of the second headband structure 30 is not increased due to the glue M1 connect to the second side-connecting band 31 and the second rear-connecting band 35. Moreover, the appearance of the second headband structure 30 can be improved.

The width W4 of the second elastic band 32 is the same or substantially the same as the width W5 of the second side-connecting band 31 and the width W6 of the second rear-connecting band 35. The length of the second side-connecting band 31 or the length of the second rear-connecting band 35 is longer than 3 times the length L2 of the second elastic band 32. The lengths of the second side-connecting band 31 and the second rear-connecting band 35, and the length L2 of the second elastic band 32 are measured along the extension path of the first headband structure 20. The widths W4, W5 and W6 are measured in the same direction. Moreover, the longest length of the second elastic band 32, which is stretched, is longer than 1.2 times or 1.5 times the second elastic band 32, which is not stretched.

Therefore, when the head-mounted display apparatus 1 is worn by the user, the location of the end 211 of the first side-connecting band 21 relative to the display device 10 can be adjusted by stretching the first elastic band 22 and the second elastic band 32, so as to stably dispose the head-mounted display apparatus 1 on the user's head.

Moreover, the elongations of the first elastic band 22 and the second elastic band 32 can be different for complying with the shape of the user's head. Therefore, the head-mounted display apparatus 1 can provide more comfort, and the head-mounted display apparatus 1 can be more stably disposed on the user's head.

In conclusion, the display device of the head-mounted display apparatus of the present disclosure can be stably disposed on the user's head using the elastic band, and the head-mounted display apparatus can provide comfort.

While the invention has been described by way of example and in terms of preferred embodiment, it is to be understood that the invention is not limited thereto. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A head-mounted display apparatus, comprising:
a display device; and
a first headband structure connected to two sides of the display device, and comprising:
a first side-connecting band connected to the display device;
a first elastic band comprising a first end and a second end, wherein the first end is connected to the first side-connecting band; and
a first rear-connecting band connected to the second end of the first elastic band;
wherein elasticity of the first elastic band is greater than elasticity of the first side-connecting band and elasticity of the first rear-connecting band, and a material of the first elastic band is different from materials of the first side-connecting band and the first rear-connecting band.

2. The head-mounted display apparatus as claimed in claim 1, wherein the first elastic band is a plurality of woven elastic fibers.

3. The head-mounted display apparatus as claimed in claim 1, wherein the first elastic band is made from a mass elasticity material.

4. The head-mounted display apparatus as claimed in claim 1, wherein the first side-connecting band comprises thermoplastic polyurethane.

5. The head-mounted display apparatus as claimed in claim 1, wherein the first side-connecting band is hard, and is non-flexible.

6. The head-mounted display apparatus as claimed in claim 1, wherein the first side-connecting band is flexible, and is not stretchable.

7. The head-mounted display apparatus as claimed in claim 1, wherein the first elastic band is not stacked on the first side-connecting band and the first rear-connecting band.

8. The head-mounted display apparatus as claimed in claim 1, wherein the first end is connected to the first side-connecting band via a first glue, and the first rear-connecting band is connected to the second end of first elastic band via a second glue.

9. The head-mounted display apparatus as claimed in claim 1, further comprising a first cladding layer covering the first side-connecting band and the first end of the first elastic band.

10. The head-mounted display apparatus as claimed in claim 9, further comprising a second cladding layer covering the first rear-connecting band and the second end of the first elastic band.

11. The head-mounted display apparatus as claimed in claim 1, further comprising a second headband structure, wherein two ends of the second headband structure are connected to the first headband structure.

12. The head-mounted display apparatus as claimed in claim 11, wherein the second headband structure comprises:
a second side-connecting band connected to the first side-connecting band;
a second elastic band connected to the second side-connecting band; and
a second rear-connecting band connected to the first elastic band,
wherein elasticity of the second elastic band is greater than elasticity of the second side-connecting band and elasticity of the second rear-connecting band, and a material of the second elastic band is different from materials of the second side-connecting band and the second rear-connecting band.

13. The head-mounted display apparatus as claimed in claim 12, wherein materials of the second elastic band and the first elastic band are the same, and materials of the first side-connecting band, the first rear-connecting band, the second side-connecting band, and the second rear-connecting band are the same.

14. The head-mounted display apparatus as claimed in claim 12, wherein the second elastic band is connected to the second side-connecting band via a third glue, and the second rear-connecting band is connected to the first elastic band via a fourth glue.

15. The head-mounted display apparatus as claimed in claim 12, further comprising a third cladding layer covering the second side-connecting band and an end of the second elastic band.

16. The head-mounted display apparatus as claimed in claim 15, further comprising a fourth cladding layer covering the second rear-connecting band and the other end of the second elastic band.

17. The head-mounted display apparatus as claimed in claim 12, wherein the first side-connecting band and the second side-connecting band are formed as a Y-shaped structure.

18. The head-mounted display apparatus as claimed in claim 1, further comprising a top headband structure connected to the first headband structure and the display device.
